(19) United States
(12) Patent Application Publication
(10) Pub. No.: US 2026/0040284 A1
(43) Pub. Date: Feb. 5, 2026

(54) METHOD AND APPARATUS FOR TRANSMISSION TIME LLOCATION FOR MULTIPLE D2R TRANSMISSIONS

(71) Applicant: INTERDIGITAL PATENT HOLDINGS, INC., Wilmington, DE (US)

(72) Inventors: Aata El Hamss, Laval (CA); Paul Marinier, Brossard (CA); Moon IL Lee, Melville, NY (US); Freda Martino, Laval (CA); Erdem Bala, East Meadow, NY (US); Remun Koirala, London (GB)

(73) Assignee: INTERDIGITAL PATENT HOLDINGS, INC., Wilmington, DE (US)

(21) Appl. No.: 18/794,226

(22) Filed: Aug. 5, 2024

(51) Int. Cl. H04W 72/0446

(52) U.S. Cl. CPC H04W 72/0446

(57) ABSTRACT

The disclosed process addresses transmission of data from a device to a reader (D2R) in communication systems where devices receive reader-to-device (R2D) transmissions. Methods to determine the appropriate time and frequency resources for the D2R transmission based on the device's sampling frequency offset (SFO) capability is disclosed. The device receives an R2D transmission in a first slot, which specifies two sets of resources for D2R transmission: a first set and a second set. The device compares its SFO capability with a pre-defined threshold. If the device's SFO capability is below the threshold, it uses resources from the first set, which are allocated to time and frequency slots occurring before a specified number of slots (N) from the first slot. Conversely, if the SFO capability exceeds the threshold, the device uses resources from the second set, which are allocated to slots occurring after N slots from the first slot.

### BACKGROUND

Further reduction of size, complexity, and power consumption of IoT devices can enable the deployment of tens or even hundreds of billion IoT devices for various applications and provide added value across the entire value chain. In some cases, it is difficult to power all the IoT devices by a battery that needs to be replaced or recharged manually, which leads to high maintenance cost, serious environmental issues, and even safety hazards for some use cases (e.g., wireless sensor in electric power and petroleum industry).

Considering the limited size and complexity required by practical applications for batteryless devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

Devices in Ambient Internet of Things (AIoT) systems typically transmit by backscattering a signal transmitted by a reader or an external source. The signal can typically consist of a single tone or continuous wave (CW) or of multiple tones transmitted simultaneously (multi-carrier) or sequentially (frequency hopping). A device may transmit information by reflecting or absorbing the signal.

Wireless communication systems can use frequency division multiplexing (FDM) to support simultaneous transmissions of different communication links. AIoT systems are expected to support FDM between device-to-reader (D2R) transmissions from different devices. For some type of devices, it can be difficult to maintain accurate timing and thus it may be challenging to transmit at an exact time. Due to weak timing capability of devices, multiplexing transmissions from different devices can lead to inter-device interference. Accordingly, there is a need to schedule multiple AIoT devices in time and frequency while avoiding/minimize inter-device interference.

### SUMMARY

The disclosed device and method addresses the transmission of data from a device to a reader (D2R) in a communication system where the device receives a reader-to-device (R2D) transmission. The method involves several steps to determine the appropriate time and frequency resources for the D2R transmission based on the device's sampling frequency offset (SFO) capability.

Initially, the device receives an R2D transmission in a first slot, which specifies two sets of resources for D2R transmission: a first set and a second set. The device then compares its SFO capability with a pre-defined threshold. If the device's SFO capability is below the threshold, it uses resources from the first set, which are allocated to time and frequency slots occurring before a specified number of slots (N) from the first slot. Conversely, if the SFO capability exceeds the threshold, the device uses resources from the second set, which are allocated to slots occurring after N slots from the first slot.

The number N of slots can be configured by the reader or preconfigured in the device. Additionally, the threshold can be set by the reader and is generally an upper bound within a range of low SFO values. The first set of resources may include multiple slots, with each successive slot offering fewer frequency resources than the previous one, or each slot may differ in the number of frequency resources provided. The D2R transmission could be a query reply message, and the number of slots in the first set may be determined based on a parameter indicated in the R2D transmission. The device is typically an ambient Internet of Things (AIoT) device.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of different device-to-receiver (D2R) transmission starting times due to different sampling frequency offset (SFO) capabilities;

FIG. 3 shows an example scheme in which the reader transmits R2D transmission in slot 0;

FIG. 4 shows an example process for a device performing a D2R transmission; and

FIG. 5 shows an example process by which the reader may indicate or trigger a device to send a D2R at a specific time or within a specific time window.

### DETAILED DESCRIPTION

The following list of acronym definitions may be referred to herein.
BWP Bandwidth Part
CA Carrier aggregation
CE Control Element
CG Configured grant or cell group
CQI Channel Quality Indicator
CRC Cyclic Redundancy Check
CSI Channel State Information
CW Contention Window
CWS Contention Window Size
CO Channel Occupancy
DCI Downlink Control Information
DG Dynamic grant
DL Downlink
DM-RS Demodulation Reference Signal
DRB Data Radio Bearer
HARQ Hybrid Automatic Repeat Request
NACK Negative ACK
MCG Master cell group
MAC Medium access control
MCS Modulation and Coding Scheme
MIMO Multiple Input Multiple Output
NR New Radio
OFDM Orthogonal Frequency-Division Multiplexing
PCell Primary cell
PCI Physical cell identity
PHY Physical Layer
PRACH Physical Random Access Channel
RO RACH occasion
RRC Radio Resource Control
SPS Semi-persistent scheduling
SUL Supplemental Uplink
TB Transport Block
TBS Transport Block Size
TRP Transmission/Reception Point
UL Uplink
WBWP Wide Bandwidth Part
WLAN Wireless Local Area Networks and related technologies (IEEE 802.xx domain)

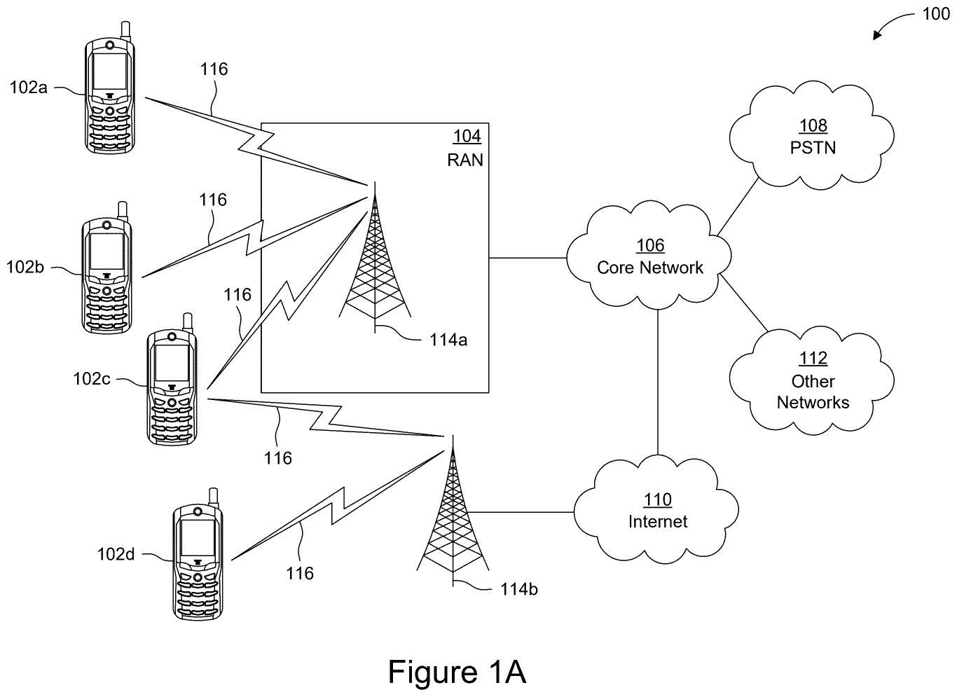

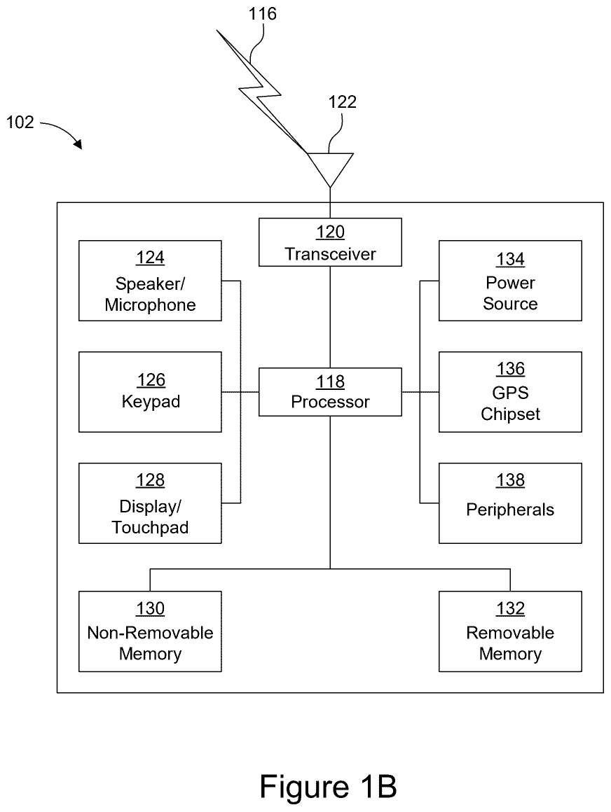

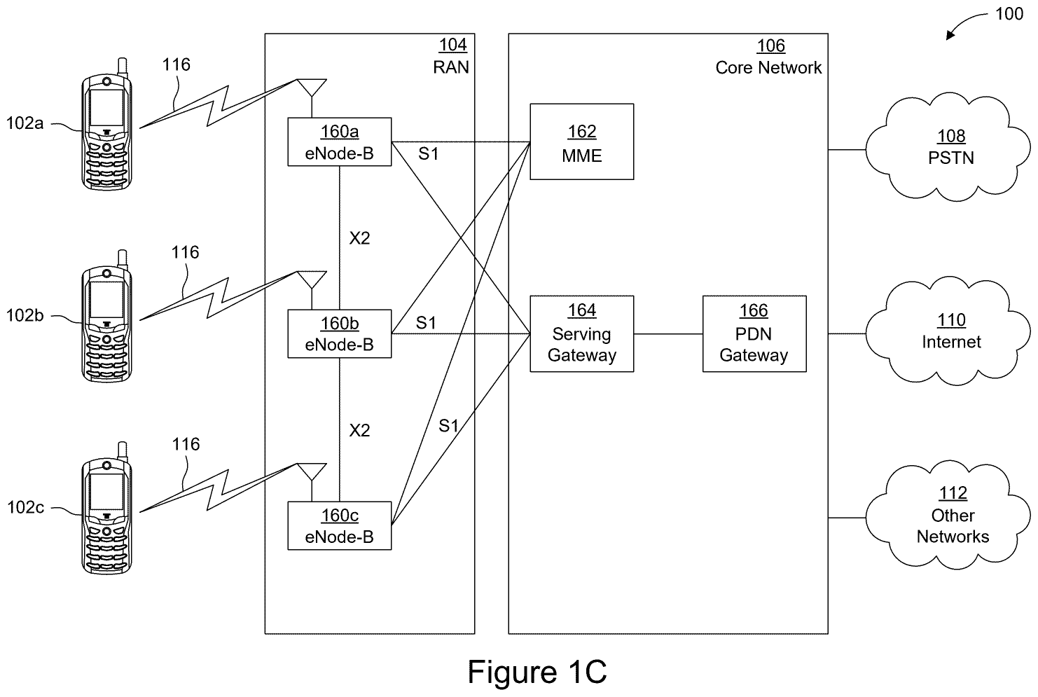

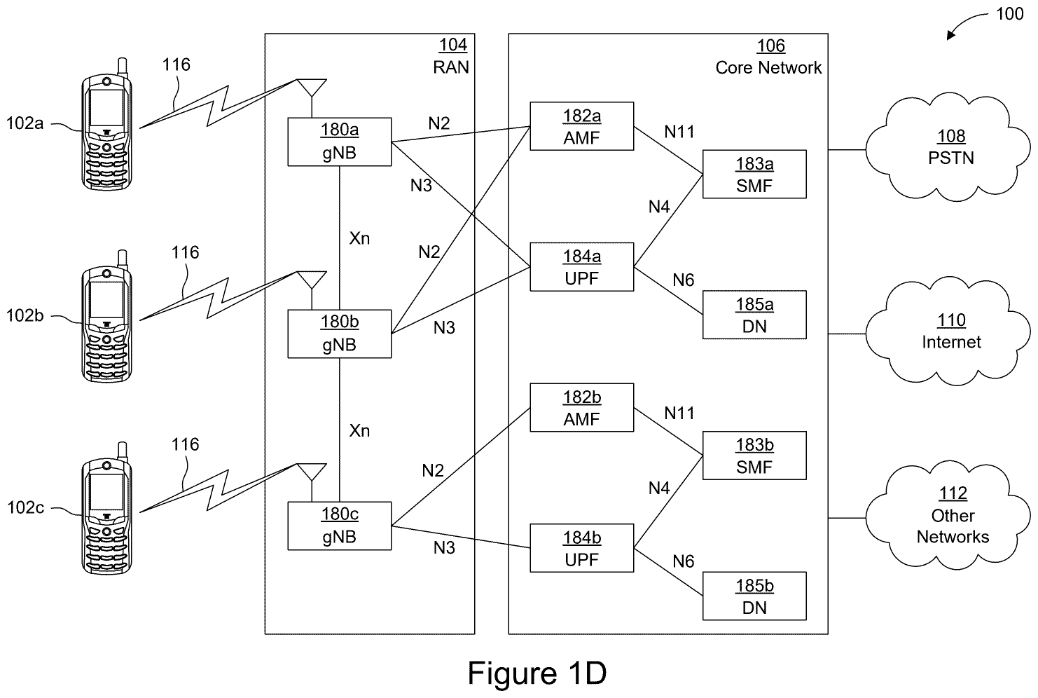

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHZ, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHZ. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For some type of devices, it can be difficult to maintain accurate timing and thus it may be challenging to transmit at an exact time. Due to weak timing capability of devices, multiplexing transmissions from different devices can lead to inter-device interference. Wireless communication systems can use frequency division multiplexing (FDM) to support simultaneous transmissions of different communication links. AIoT systems are expected to support FDM between device-to-reader transmissions from different devices. Each device can shift the reflected signal in frequency domain. Different shift can be applied by different devices to enable FDM multiplexing. To avoid interference from the different multiplexed transmissions, the multiple transmissions should be transmitted at approximately the same time.

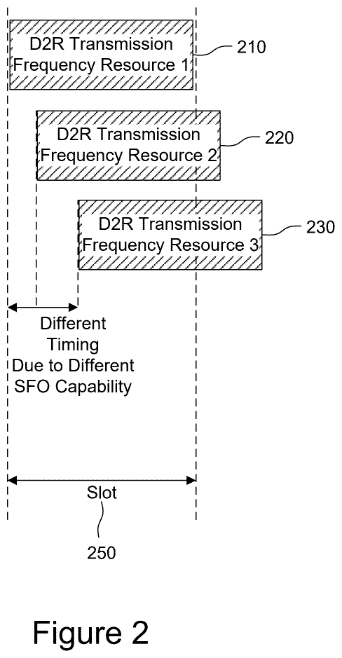

FIG. 2 shows an example of different device-to-receiver (D2R) transmission starting times due to different sampling frequency offset (SFO) capabilities. Each of the transmissions, 210, 220, and 230, are scheduled to transmit in slot 250, however, the actual transmissions have occurred at different times within the slot due to the devices having differing SFO capabilities.

The terms device, AIoT UE, and TAG are used interchangeably to mean the AIoT device that is being inventoried or queried by the reader.

The term reader refers to the entity which queries the AIoT device, either directly, or via an intermediate WTRU in topology 2. The term reader in topology 2 may also refer to the intermediate WTRU. As a result, the term reader may refer to a network node, UE, or WTRU, depending on the context and/or the topology.

The terms reader, network, intermediate UE, and WTRU may be used interchangeably to mean the reader throughout the present application.

In some cases herein, SFO capability can be associated with sampling frequency offset (SFO) and/or maximum SFO that can occur while transmitting/receiving. The device can determine its SFO capability based on one or more of the following: Timing shift from a reference time indicated from the reader; programmed or configured SFO value in the internal memory of the device; and/or jitter period where the jitter period is the deviation of the device's clock signal with respect to a reference point indicated by the reader.

Herein, a device type may refer to the SFO capability of the device, or a synchronization capability, or any other capability of the device to keep accurate time. For example, a first device type can be associated with a first SFO range, and a second device type can be associated with a second SFO range. Alternatively, a first device type may be associated with a first range of synchronization capability, and second device type may be associate with a second synchronization capability. In another example, a device type can be associated with a jitter value/range, where a jitter refers to a time delay in the transmission caused by inaccurate timing at the device side. In the following solutions, SFO can be replaced by jitter.

Herein, inventory refers to the overall procedure of a reader triggering access by multiple devices using a sequence of messages (e.g., similar to query, followed by query rep in RFID). Specifically, the inventory procedure refers to a single round of attempts to have each device respond or attempt to respond with its access ID, or perform a RACH procedure. Specifically, the inventory procedure refers to a set of access occasions which may have 0 or at least 1 device respond within the access occasion.

Inventory procedure may occur similar to legacy RFID procedure. Although referred to herein as inventory procedure, it may be termed differently in device requirements or specifications (e.g., query procedure, paging procedure, etc).

Herein, occasion refers to the opportunity for device transmission that may be delimited by the transmission of a query rep message (or similar). Specifically, a device may perform transmission in an occasion by performing a AIoT transmission in a defined time following the query rep associated with that transmission. Alternatively, an occasion may consist of both a time aspect and a frequency aspect. Specifically, a device may determine an occasion as a transmission following a specific query rep, and by transmitting on one of a number of frequencies (e.g., FDM). Wherever solutions indicate selection of an occasion, they can apply equivalently to selection of only a time component and/or selection of a frequency component. A frequency aspect may be associated with a sequence (e.g. a chip sequence) used for modulating a device transmission. Therefore, an occasion may consist of both a time aspect and a sequence.

Herein, depending on the solution or description, any reference to time can be associated with an absolute time measurement (e.g., seconds, slots, frames, etc). Alternatively, it can refer to a number of executions of a procedure, possibly triggered by a reader (e.g., number of inventory procedures, number of accesses or RACH procedures, etc). Alternatively, it can refer to a number of messages, possibly of a specific type, or containing specific information, as described herein, received or transmitted. Time may be measured by a timer device, counter, and the like.

Configuration or pre-configuration may refer to any configuration received by a message (e.g., an RRC message, a MAC CE, a PHY layer signal, a data PDU, a control PDU associated with any or a new protocol layer, etc) received from either a network node, or from another device or WTRU.

A device herein may be configured by the reader, whereby the reader may be a network node or a WTRU (e.g., intermediate UE in topology 2). In the case of a WTRU, the WTRU may derive the device configuration itself, or receive the device configuration from the network, in which case, the device configuration is being relayed from the network to the device by the WTRU.

On the other hand, a WTRU configuration (e.g., in the case of a UE in topology 2) may be received from a network node (e.g., the gNB).

Herein, a query message may refer to a message transmitted by a reader to one or multiple devices. The query message can carry a command to one or multiple devices in reader-to-device (R2D) channel. For example, such command may be a request to one or multiple devices to identify themselves. In another example, the query message can be a command requesting one or multiple devices to report some information to the reader. The query message can be a broadcast or groupcast or unicast message. A query reply message may refer to a message transmitted by a device to the reader following the reception of query message(s). A query reply message may be transmitted on device-to-reader (D2R) channel in response of query message(s). The query reply message may carry device ID and/or additional information. Such information may be requested by the query message from the reader. In some solutions, the device may select a random D2R resource to transmit query reply message. In another solution, the device may select D2R resource to transmit query reply according to a predefined rule. In another solution, the reader may assign to the device a D2R resource to transmit query reply message. The assignment of the query reply resource can be included in the query message. For example, a query message transmitted to a group of devices may include a set of resources for D2R transmission and/or a subset of resources from which the device should select the resource to transmit query reply message. In another example, the query message can indicate the exact resource to use for query reply transmission.

The reader may repeat the query message in multiple time instances to accommodate unsuccessful transmissions from devices and/or give more resources to use for query reply transmissions.

Herein, the reader may configure multiple frequency resources in the same slot using FDM. Such configuration may include one or more of the following: bandwidth of AIoT carrier; number of frequency resources within the AIoT carrier. For example, the bandwidth can be divided into multiple subchannels, where each subchannel can be used for different D2R transmission; and/or guard band/frequency offset/spacing between frequency resources/subchannels.

In one example, the device is configured explicitly with the AIoT FDM parameters listed above. In another solution, the device determines one or multiple AIoT FDM parameters (described above) based on its SFO capability. For example, a device can be configured with a bandwidth of AIoT carrier, and the device determines the guard band between subchannels based on the devices SFO value. The device can be pre-configured with a mapping between SFO values and guard bands/frequency offsets/spacing between frequency resources.

In an example, the reader may configure a different number of frequency resources for D2R transmissions in different slots. For example, the reader transmits a R2D transmission and then indicates that the first K slots after the R2D transmission have N_{K} frequency resources to be FDMed. The next L slots (slots K+L to K+L after R2D transmission) have N_{L} frequency resources. The next M slots (slots K+L+1 to K+L+M after R2D transmission) have N_{M} frequency resources, where N_{K}>N_{L}>N_{M}. The number of frequency resources per slot keeps decreasing until it reaches single frequency resource per slot.

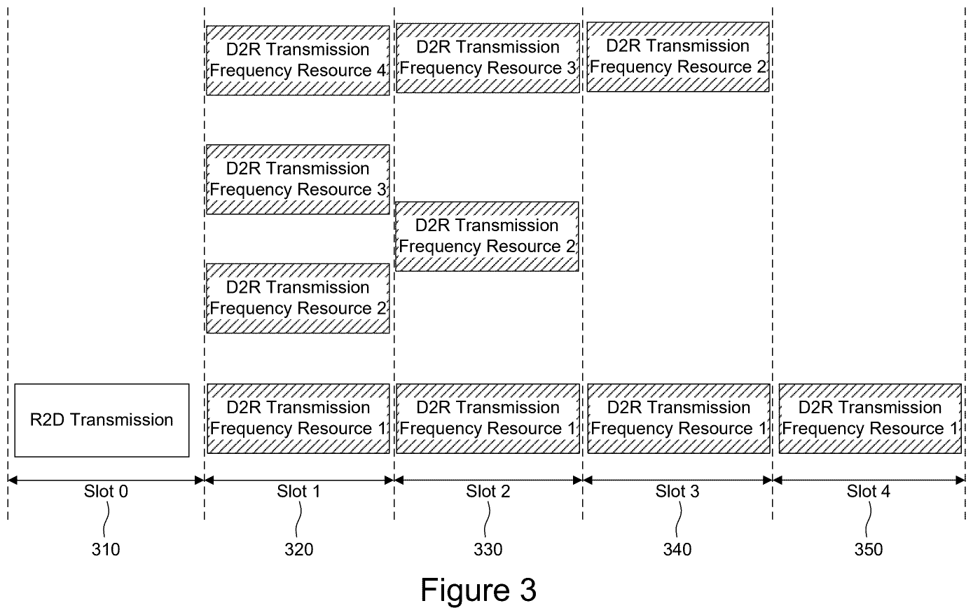

FIG. 3 shows an example scheme in which the reader transmits R2D transmission in slot 0 310. In the R2D transmission the reader indicates that the slot for D2R transmission following R2D transmission 320 has 4 frequency resources and the slot after 330 has 3 frequency resources and the slot after 340 has 2 frequency resources and the slot after 350 has a single frequency resource. Such indication can be transmitted in the query message in the R2D transmission or otherwise configured in the devices.

In some solutions, the reader may assign a transmission time for the device to transmit D2R transmission. The reader can indicate to the device the transmission time for D2R using one, or a combination of, the following three approaches.

Approach 1: A time slot where the device can transmit D2R transmission. The reader indication can be a number of slots after the R2D transmission.

Approach 2: A time window where the device can transmit D2R transmission. For example, the reader can indicate to the device a minimum and/or maximum time after the R2D transmission.

Approach 3: D2R transmission time is following R2D transmission immediately.

In some examples, the start time of a slot may be obtained by multiplying its slot index by a fixed slot interval, where the slot interval may be pre-defined or indicated in the R2D transmission. Alternatively, the start time of a slot with index n may be obtained as the sum of the start time of index (n-1) and a slot interval whose value depends on the index n. For example, the difference between start times of index (n) and (n-1) may be the sum of a minimum slot interval Tsmin and of an additional offset proportional to index n. For example, the additional offset may be the product of index n times a constant. The value of the constant may be pre-defined or indicated in the R2D transmission. This example may have the benefit of increasing robustness to timing differences between devices by reducing the probability of time overlap.

In some examples the device may select the time and frequency resources for D2R transmission based on the SFO threshold. More specifically, the device may be configured with a sampling frequency offset (SFO) threshold. The device may use the configured SFO thresholds to determine/prioritize a set/sub-set of resources from which to select a resource to transmit query reply message. For example, if the device's own SFO is above the configured SFO threshold, the device can select/prioritize a query reply resource from a first set of D2R resources. If the device's own SFO is below the configured SFO threshold, the device can select/prioritize a query reply resource from a second set of D2R resources. The first and second set of D2R resources may have some common resources and some different resources. The device can be configured with multiple SFO ranges, and each SFO range can be associated with a set/sub-set of D2R resources. The device selects/prioritizes a D2R resource from the sub-set of resources associated with SFO range in which the device's SFO belongs to. The set/sub-set of resources can include a number of time slots and/or number of frequency resources. When associating a sub-set of resources to SFO range, a limited number of resources and/or number of frequency resources are prioritized for device selection with SFO in that SFO range. For example, a total number of 10 slots are available for device selection. If the device has SFO that is associated with a number of 5 slots, the device prioritizes that selection of D2R resource from 5 slots instead of 10 slots.

In some examples, the device may be configured with a number of slots N from which the device can select/prioritize a D2R resource for query reply transmission. Such N number can be lower than the total number of slots available for D2R resources for query reply transmission. In one example solution, each slot of the N of slots can have the same number of frequency resources per slot. In another example solution, not all the N slots have the same frequency resource per slot. The device can be configured with multiple numbers of N slots, each number is associated with SFO threshold. The device can select a number N of slots based on its capability i.e., the device's SFO value/capability.

In some examples, the device can determine the number of slots N from which the device can select/prioritize a D2R resource for query reply transmission based on the indicated device type by the reader. For example, the reader sends a query message indicating to which type of devices the query is sent for. From the indicated type of devices, the device can determine the value of N. The types of device can be associate to a value of SFO range.

In one example solution, for high SFO value, the number N of slots can be the right next slots after R2D transmission. For the small SFO value, the N number of slots are separated by a time gap after the R2D transmission.

In some examples, the device may be configured with a number of slots from which the device can select a D2R resource for query reply transmission. Such indication can be transmitted by the reader to the device using the R2D transmission carrying the query message. In one example solution, the reader can explicitly indicate to a group of devices the number of available slots after R2D transmission from which devices can select a D2R resource for query reply. In one example solution, the number of slots can be derived from another parameter indicated in R2D transmission. For example, the reader can indicate a parameter Q in the R2D transmission, and the devices determine that the number of slots (or resources) available for D2R transmissions is equal to 2^{Q}-1.

In some examples, the reader can indicate multiple sets of slots to the devices, where each set of slots can be used by devices that have certain SFO capability. In one example, the reader can indicate the SFO range along the multiple set of slots in the R2D transmission carrying the query message. In another example, the device can determine the SFO range from the indicated multiple sets of slots. For example, the first set of slots corresponds to the first SFO range and the second set of slots corresponds to the second SFO range.

In some examples, the reader can indicate a total number of slots for all device types (i.e., with different SFO values) for query reply message and each device can derive the available number for its device type using a pre-configured formula. For example, the device can multiply the indicated total number of slots by a factor to obtain the number of available slots N for its device type, and such factor can be associated with the device type. Devices with higher SFO can be configured with a multiplying factor smaller than 1 and devices with lower SFO can be configured with a multiplying factor larger than 1.

In some examples, the device can be indicated by SFO threshold and a set of D2R resources in the same R2D transmission. Only devices with SFO below the indicated threshold can use the indicated set of D2R resources.

In some examples, the device can be configured to select a D2R resource for query reply message transmission according to its SFO capability i.e., SFO range of the device. In one solution, the device can be provided with multiple sets of time and frequency resources, each set is associated with SFO range. Based on the device SFO capability, the device selects the set of time and frequency resources to use for D2R resource selection (D2R resource to carry query reply). The device then selects randomly from the selected set of time and frequency resource to use for D2R transmission. The random selection of the device within the identified set can ensure that devices with a similar SFO range are distributed to avoid collisions.

In some examples, a device may first determine the available number of resources M following a query transmission. Such number may depend on the device type or SFO capability as described in the above. The device may then index resources as follows: Resources following first R2D transmission (e.g. query or queryrep) are indexed from 0 to M-1, resources following second R2D transmission are indexed from M to 2M-1, resources following the Lth R2D transmission are indexed from (L-1)*M to L*M-1, and so on. The index or order of the R2D transmission may by indicated within the R2D transmission, or alternatively may be increased by 1 for every reception of the R2D transmission indicating a new set of resources. The device then selects a random number within a range indicated by the R2D transmission (e.g. an initial R2D transmission), for example by selecting within range 0 to 2^{Q}-1 where Q is indicated in the R2D transmission. The device may set the resource index as this random number and determine which resource to use accordingly, including after which R2D transmission the resource occurs, based on the above-described indexing.

In another example, the device can be configured with a set of time and frequency resources and the device selects/prioritizes the selection of a resource within N slots after the R2D transmission, and the device determines the value of N based on its SFO capability (as described above). In one example solution, the device can prioritize the selection of a resource within N slots by generating a random number that follows a certain probability distribution function (PDF). For example, each slot has K frequency resources. The device indexes the resources in frequency first and then in time domain. The device then prioritizes the resource selection from 1 to K*N by generating a random variable with a PDF that gives very low probability to have random number above K*N (e.g., exponential distribution with lambda parameter such as Pr(X>K*N) is close to 1). In another example, the device can uniformly select a resource only from 1 to K*N.

In some examples, devices with high synchronization capability (similar to a small SFO value) can be configured to select from all the indicated time and frequency resources, including the time and frequency resources configured for devices with weak synchronization capability (similar to a high SFO value). Alternatively, devices with high synchronization capability (small SFO value) can be configured to avoid selecting/deprioritize the selection from the indicated time and frequency resources for devices with weak synchronization capability (high SFO value).

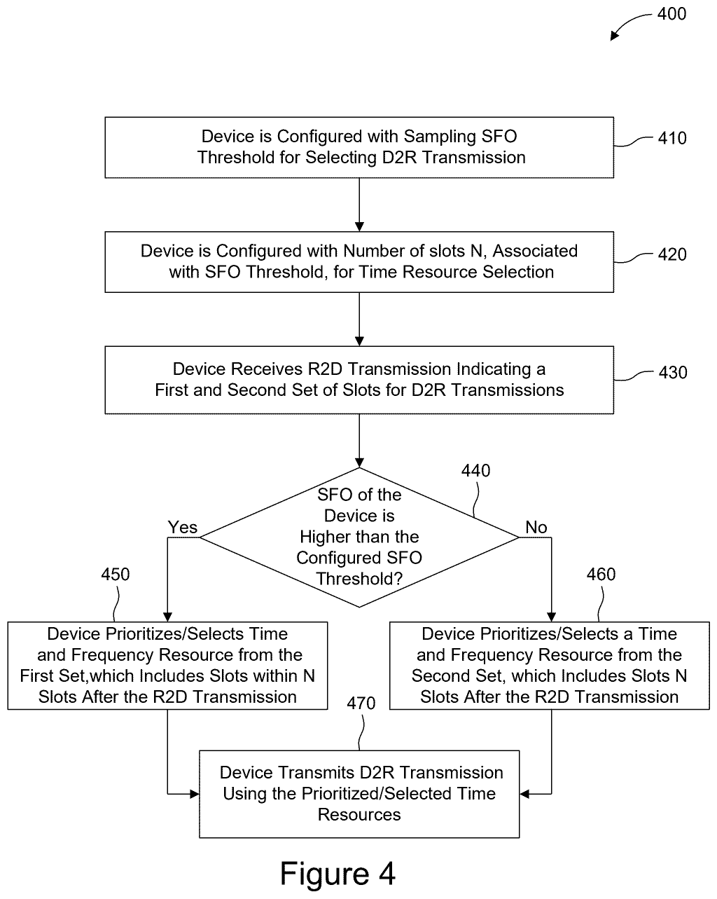

FIG. 4 shows an example process 400 for a device performing a D2R transmission. At 410, the device is configured with a sampling frequency offset (SFO) threshold for selecting a D2R transmission slot and/or frequency resources within a slot. At 420, the device is configured with a number of slots N to be used for selecting a D2R transmission slot and/or frequency resources within a slot. At 430, the device receives an R2D transmission indicating a first and second set of slots and/or frequency resources for each slot available for use for D2R transmission. In one example, the first set includes slots with in N slots of R2D transmission and the second set of slots includes slots after N slots from the R2D transmission. At 440, the device selects a slot and/or frequency resource from either the first set or the second set of slots for its D2R transmission based on the SFO capability of the device. In the case that the SFO capability of the device is higher than the configured SFO threshold, the device prioritizes resources within the first set, which includes the N slots after the R2D transmission, at 450. For example, if the SFO capability is higher than the configured SFO threshold, the device may select using a first formula, a time and frequency resource, where the selection probability within N slots after the R2D transmission is higher than other slots in the indicated set of slots. In the case that the SFO capability is lower than the configured SFO threshold, the device prioritizes resources in the second set, which includes slots after N slots of the R2D transmission, at 460. For example, the device may select using a second formula, a time and frequency resource, where the selection probability within the N slots after the R2D transmission is smaller than other slots in the indicated set of slots. Finally, the device transmits a D2R transmission using the selected resources at 470.

In some examples the reader may select and indicate the time and frequency resources for the device.

In one example, the reader is configured to determine the SFO capability of a device. The reader can request the device to report its SFO capability. Alternatively, the reader can determine the SFO capability of the device based on transmissions performed by the device. For example, the reader can configure the device to send one or multiple preamble(s). The reader can determine SFO capability from measuring the received preambles.

In another example, the reader can be configured to determine the number of devices to be scheduled in proximity of the reader. The reader can determine the number of devices by sending a short message to devices and based on the received responses, determine the number of devices in proximity. The reader then schedules the devices accordingly.

In some examples, the reader can be configured to determine the transmission time indication type for devices (e.g., whether to indicate a time slot, time window or following the reader transmission immediately) based on one or more of the following: frequency domain multiplexing parameters for D2R transmissions; reader capabilities; device capability/type; type of transmission/command type; existence of synchronization signals after D2R transmission; R2D and transmission duration.

With respect to the frequency domain multiplexing parameters for D2R transmissions. The reader can determine the time indication type based on one or more of the frequency domain multiplexing parameters: system bandwidth allocated for AIoT; number of frequency resources within the bandwidth allocated for each AIoT transmission; or guard band/frequency offset/frequency spacing between the different frequency resources. For example, the reader can indicate a time slot for D2R transmission if the frequency spacing between different frequency resources is larger than a threshold. The D2R transmissions can coexist without interfering with each other.

With respect to reader capabilities, for example, if the reader can suppress the interference caused by two adjacent D2R transmissions in frequency domain, the reader can indicate a time slot to devices for D2R the transmission.

With respect to device capability/type, for example, based on the capability of the devices to be scheduled, the reader can determine the transmission time type indication. The device capability can be one or more of the following: synchronization capability such as SFO and jitter; energy level of the device; or the type of the transmission/command type. In the case of the type of the transmission/command, the time type indication can depend on the type of transmission e.g., whether read maybe the read needs more time and then select window or write command.

With respect to the existence of synchronization signals after R2D transmission allowing the device to maintain the timing, for example, if the reader will transmit a synchronization signal after/between D2R transmission, the reader can indicate a time slot for D2R transmission. Otherwise, the reader can indicate that D2R transmission follows immediately the R2D transmission.

With respect to the R2D transmission duration, for example, the reader can select the transmission type indication based on the duration of the R2D transmission. For short R2D transmission duration, the reader may indicate an exact transmission to be indicated for D2R transmission. For long R2D transmission duration, the reader may provide a time window instead of an exact transmission time.

In some examples, the reader can be configured to determine transmission time indication type based on the command type. The reader/device can be configured with an association between the command types and the transmission time indication types. In one example, the reader can indicate the command type without indicating the transmission time indication type to devices. In this case the device determines transmission time for D2R transmission based on the command type.

In some examples, the reader can be configured by the network to use transmission time indication type. For example, in certain deployment scenario, a WTRU may be configured by the gNB to act as a reader. The gNB can configure the WTRU with transmission time type to indicate to devices when scheduling/triggering devices may transmit.

In some examples, the reader can be configured to assist a device with poor synchronization capability to transmit at specific time slot. The reader can be configured to use an R2D preamble prior to D2R transmission to enable device transmission at specific time. As a first step, the reader can indicate in R2D transmission the D2R transmission parameters for the device, where the transmission time is not scheduled to be immediately after the R2D transmission. As a second step, a follow up R2D transmission for the purpose of just triggering an already scheduled D2R transmission to have the transmission at an exact time.

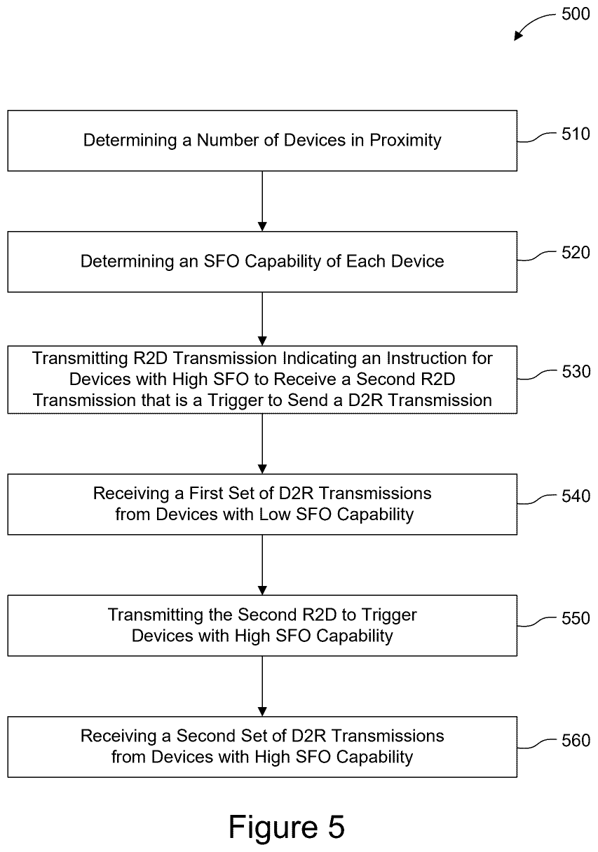

FIG. 5 shows an example process 500 by which the reader may indicate or trigger a device to send a D2R at a specific time or within a specific time window. At 510, a reader may determine a number of devices in proximity to the reader. At 520, a reader may determine the SFO capability of each device using any of the methods described herein. At 530, the reader transmits an R2D transmission indicating an instructions for devices with higher SFO to receive a second R2D transmission that is a trigger or indicator to send a D2R transmission. At 540, the a first set of D2R transmissions are received from devices having a low SFO capability. At 550, the reader may transmit a second R2D transmission to trigger or indicate devices with a high SFO capability to send D2R transmissions either right away or with in a window. At 560 the reader may receive a second set of D2R transmissions from devices with high SFO capability. It should be noted that all though the process of 500 is shown in a specific order various steps may be omitted or reordered. For example the reader may already know which devices are in proximity and step 510 may be omitted. In another example, a reader may already know the SFO capability of each device and step 520 may be omitted. In another example, steps 540 and 550 may be re ordered.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A performing a device to reader (D2R) transmission, the method comprising:
receiving a reader to device (R2D) transmission in a first slot, wherein the R2D transmission indicates a first and a second set of resources to use for a D2R transmissions;
comparing a sampling frequency offset (SFO) capability of the device with a threshold; and
on a condition that the SFO capability of the device is less than the threshold, transmitting the D2R transmission using resources from a first set of time and frequency resources that occur before N slots after the first slot; and
on a condition that the SFO capability of the device is greater than the threshold, transmitting the D2R transmission using resources from the second set of time and frequency resources that occur after N slots after the first slot.

2. The method of claim 1, further comprising receiving, by the device from a reader, information indicating a number N representing a number of slots after the slot in which the R2D transmission is received.

3. The method of claim 1, wherein the number N representing a number of slots after the slot in which the R2D transmission is preconfigured in the device.

4. The method of claim 1, further comprising receiving, by the device from a reader, information indicating the threshold.

5. The method of claim 1, wherein the first set of time and frequency resources includes resources from a plurality of slots, and each successive slot after the first slot in the plurality has less frequency resources than an immediately preceding slot.

6. The method of claim 1, wherein the D2R transmission is a query reply message.

7. The method of claim 1, wherein in the first set of time and frequency resources includes resources from a plurality of slots and each slot associated with in the first set of time and frequency resources includes a different number of frequency resources.

8. The method of claim 1, wherein the number of slots associated with the first set of time and frequency resources is based on a parameter indicated in the R2D transmission.

9. The method of claim 1, wherein the threshold is an upper bound in a range of SFO values that define a category of low SFO capability.

10. The method of claim 1, wherein the device is an ambient Internet of Things AIoT device.

11. A device for performing a device to reader (D2R) transmission, the device comprising:
a receiver;
a transmitter; and
a processor, wherein the receiver, the transmitter and processor are configured to:
receive a reader to device (R2D) transmission in a first slot, wherein the R2D transmission indicates a first and a second set of resources to use for a D2R transmissions;
compare a sampling frequency offset (SFO) capability of the device with a threshold; and
on a condition that the SFO capability of the device is less than the threshold, transmit the D2R transmission using resources from a first set of time and frequency resources that occur before N slots after the first slot; and
on a condition that the SFO capability of the device is greater than the threshold, transmit the D2R transmission using resources from the second set of time and frequency resources that occur after N slots after the first slot.

12. The device of claim 11, wherein processor, transmitter and receiver are further configured to receive from a reader, information indicating a number N representing a number of slots after the slot in which the R2D transmission is received.

13. The device of claim 11, wherein the number N representing a number of slots after the slot in which the R2D transmission is preconfigured in the device.

14. The device of claim 11, wherein the processor, the transmitter, and the receiver are further configured to receive the threshold from the reader.

15. The device of claim 11, wherein the first set of time and frequency resources includes a plurality of slots, and each successive slot after the first slot in the plurality has less frequency resources than immediately preceding slot.

16. The device of claim 11, wherein the D2R transmission is a query reply message.

17. The device of claim 11, wherein in the first set of time and frequency resources includes a plurality of slots and each slot with in the first set includes a different number of frequency resources.

18. The method of claim 11, wherein the number of slots in the first set of time and frequency resources is based on a parameter signaled in the R2D transmission.

19. The method of claim 11, wherein the threshold is an upper bound in a range of SFO values that define a category of low SFO capability.

20. The method of claim 11, wherein the device is an ambient Internet of Things AIoT device.
